(19) United States
(12) Patent Application Publication
(10) Pub. No.: US 2016/0235106 A1
(43) Pub. Date: Aug. 18, 2016

(54) JERUSALEM ARTICHOKE DRINK

(71) Applicant: BRIU GMBH, Königstein (DE)

(72) Inventor: Uwe-Bernd Rose, Koenigstein (DE)

(73) Assignee: BRIU GmbH, Koenigstein (DE)

(21) Appl. No.: 15/026,294

(22) PCT Filed: Aug. 7, 2014
(86) PCT No.: PCT/DE2014/200387

§ 371 Date: Mar. 31, 2016

(30) Foreign Application Priority Data
Oct. 4, 2013 (DE) 10 2013 220 111.7

(51) Int. Cl. A23L 2/02; A23L 2/52

(52) U.S. Cl. CPC A23L 2/02; A23L 2/52; A23V 2002/00

(57) ABSTRACT

The invention relates to a drink which contains at least 50 wt.-% of Jerusalem artichoke juice, at least 1 wt.-% of a flavor relative to its total mass in order to mask the taste of cynarine and 0.5 to 7 wt.-% of silicic acid or silicic acid derivatives. The drink is based on natural raw materials and has a high percentage of inulin and alters, due to the added flavor, the taste of artichoke which is often perceived as unpleasant.

The invention relates to a Jerusalem artichoke-based beverage.

The Jerusalem artichoke plant contains inulin, which is known as an appetite suppressant in the prior art. The objective of the invention is to provide a beverage of the type mentioned above, which has an appetite suppressant effect based on natural ingredients and is acceptable for the consumer's senses and taste.

This objective is solved with a beverage containing:
a) at least 50 percent in weight of Jerusalem artichoke juice;
b) at least 1 percent in weight of a flavor carrier to mask the taste of cynarine;
c) 0.5 to 7 percent in weight of silicic acid or silicic acid derivatives.

We would like to start with an explanation of some terms used within the scope of the invention. The term beverage is used broadly in the invention, and includes any drinkable composition including compositions or dispersions with greater viscosity, such as for example smoothies.

According to the invention, the beverage contains at least 50 percent in weight of Jerusalem artichoke juice, which is obtained as pressed juice from Jerusalem artichoke tubers. Inulin can be introduced into the beverage on the basis of a natural raw material by way of said Jerusalem artichoke juice.

The invention has recognized that Jerusalem artichoke juice can introduce an undesirable bitter taste that resembles approximately the taste of an artichoke into the beverage and is caused by the bitterant cynarine. Artichokes likewise contain cynarine.

According to the invention, it is therefore provided that the beverage contains at least 1 percent in weight of a flavor carrier relative to its total mass, to mask the taste of cynarine. In the context of the present invention, said type of flavor carrier is capable of masking the undesirable, cynarine-related artichoke flavor present in the ready-to-drink beverage at least to the point where consumers no longer perceive it as being unpleasant.

Inulin is not broken down in the gastrointestinal tract of most people. However, the gut flora of nearly one fifth of humans contains enzymes that are capable of breaking down inulin. Said breakdown can result in bloating.

Therefore, the beverage additionally contains substances to mitigate bloating, selected from the group consisting of silicic acids and silicic acid derivatives, more preferably silicas or silica gels. The beverage preferably contains 0.5 to 7 percent in weight, more preferably 1 to 5 percent in weight of silicas or silica gels.

Thus, the quintessence of the invention on the one hand is to introduce the appetite suppressant inulin on the basis of a natural raw material (Jerusalem artichoke juice) into a beverage, while on the other hand firstly recognizing two negative consequences (undesirable artichoke flavor, bloating) associated with said introduction and secondly compensating them with suitable additives (flavor carriers and/or silicas).

The flavor carrier can preferably be selected from the group consisting of fruit syrups and fruit juices. The puree or juice of raw fruits, concentrated apple juice, concentrated pear juice and lemon juice are preferable.

All of these flavor carriers are characterized in that they mask and/or compensate the undesirable flavor component of the Jerusalem artichoke juice caused by cynarine on the one hand, while advantageously enhancing the flavor of the beverage on the other hand. Within the scope of the invention, said type of flavor carrier can at the same time act as sweetener, because fruit juices contain for example sugar. Suitable examples among the concentrated fruit juices and syrups are concentrated apple or pear juice.

The ratio of flavor carrier in the beverage is preferably 1 to 15 percent in weight, more preferably 2 to 10 percent in weight.

Within the scope of the invention, the ratio of Jerusalem artichoke juice is preferably 50 to 90 percent in weight, more preferably 60 to 90 percent in weight, more preferably 70 to 90 and/or 80 to 90 percent in weight. Thus, the invention can introduce an amount of inulin into the beverage that is effective in suppressing the appetite, while its taste is not at all or at the very most compromised to an acceptable degree for the consumer on the other hand.

According to the invention, the beverage can additionally contain Jerusalem artichoke syrup. This is a product obtained by further processing the pressed juice from Jerusalem artichokes, which is preferably concentrated at a volume ratio of 1:5. By concentrating it, the composition of the juice may be altered, and in particular its fructose content may increase.

According to the invention, the ratio of Jerusalem artichoke syrup can be 1 to 15 percent in weight, more preferably 2 to 10 percent in weight, more preferably 2 to 5 percent in weight.

According to the invention, it is possible to give the beverage the consistency of a smoothie and to disperse solids in it for this purpose. To this end, it preferably additionally contains pomace of the Jerusalem artichoke, which is obtained by squeezing out the tuber of the Jerusalem artichoke and by preferably finely grinding it prior to adding it to the beverage. According to the invention, the ratio of Jerusalem artichoke pomace in the beverage can be 5 to 20 percent in weight, more preferably 5 to 10 percent in weight.

Exemplary embodiments of the invention are explained below.

### EXAMPLE 1

A beverage according to the invention is produced by mixing the following ingredients:

Pressed juice from Jerusalem artichokes, 89 percent in weight

Jerusalem artichoke syrup, 5 percent in weight

Lemon juice, 2.5 percent in weight

Silica gel, 3.5 percent in weight.

A beverage with relatively low viscosity and a high inulin ratio on the basis of natural raw materials is obtained. The addition of lemon juice enhances the flavor and masks the undesirable cynarine taste, while the addition of silica gel prevents bloating in individuals in whom inulin cannot be broken down in the gastrointestinal tract.

### EXAMPLE 2

A smoothie is prepared in this example.

500 g of Jerusalem artichoke tubers are dejuiced. Approximately 250 mL of pressed juice and approximately 250 g of pomace are obtained.

200 mL of pressed juice, 40 g of pomace, 13 g of silica gel and 10 g of concentrated pear juice are mixed in a conventional mixer at the highest setting for about 3 minutes and topped off with water to an amount of 250 mL.

A viscous liquid is obtained, whose consistency corresponds to commercially available fruit smoothies. The color approximately resembles the one of apple sauce.

1. A beverage, characterized in that it contains:
a) at least 50 percent in weight of Jerusalem artichoke juice,
b) at least 1 percent in weight of a flavor carrier for masking the taste of cynarine,
c) 0.5 to 7 percent in weight of silicic acid or silicic acid derivatives.

2. A beverage according to claim 1, characterized in that the flavor carrier for masking the taste of cynarine is selected from the group consisting of fruit syrups, concentrated fruit juices, fruit puree, fruit juices and hazelnut syrup.

3. A beverage according to claim 2, characterized in that the flavor carrier for masking the taste of cynarine is selected from the group consisting of the puree or juice of raw fruits, concentrated apple juice, concentrated pear juice and lemon juice.

4. A beverage according to claim 1, characterized in that it contains 1 to 15 percent in weight of a flavor carrier for masking the taste of cynarine.

5. A beverage according to claim 1, characterized in that the ratio of Jerusalem artichoke juice is 50 to 90 percent in weight.

6. A beverage according to claim 1, characterized in that it additionally contains Jerusalem artichoke syrup.

7. A beverage according to claim 6, characterized in that the ratio of Jerusalem artichoke syrup is 1 to 15 percent in weight.

8. A beverage according to claim 1, characterized in that it contains 1 to 5 percent in weight of silicas or silica gels.

9. A beverage according to claim 1, characterized in that it additionally contains Jerusalem artichoke pomace.

10. A beverage according to claim 9, characterized in that the ratio of Jerusalem artichoke pomace is 5 to 20 percent in weight.

11. A beverage according to claim 9, characterized in that the Jerusalem artichoke pomace is finely ground.

12. A beverage according to claim 4, characterized in that it contains 2 to 10 percent in weight of a flavor carrier for masking the taste of cynarine.

13. The beverage according to claim 5, characterized in that the ratio of Jerusalem artichoke juice is 60 to 90 percent in weight.

14. The beverage according to claim 13, characterized in that the ratio of Jerusalem artichoke juice is 70 to 90 percent in weight.

15. The beverage according to claim 14, characterized in that the ratio of Jerusalem artichoke juice is 80 to 90 percent in weight.

16. The beverage according to claim 7, characterized in that the ratio of Jerusalem artichoke syrup is 2 to 10 percent in weight.

17. The beverage according to claim 16, characterized in that the ratio of Jerusalem artichoke syrup is 2 to 5 percent in weight.

18. The beverage according to claim 10, characterized in that the ratio of Jerusalem artichoke pomace is 5 to 10 percent in weight.
